(19) United States
(12) Patent Application Publication
(10) Pub. No.: US 2026/0353476 A1
(43) Pub. Date: Nov. 5, 2026

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/121,515

(22) PCT Filed: Oct. 20, 2022
(86) PCT No.: PCT/CN2022/126540

§ 371 Date: Apr. 16, 2025

(51) Int. Cl. H04W 76/10; H04W 48/08; H04W 56/00

(52) U.S. Cl. CPC H04W 76/10; H04W 48/08; H04W 56/001

(57) ABSTRACT

The embodiments of the present disclosure relate to the technical field of communications. Provided are a communication method and apparatus, and a device and a storage medium, which can be applied to a first AP device. The method comprises: determining a first message frame, wherein the first message frame comprises first communication information, the first communication information comprises a first communication time period in which a first AP device communicates with at least one first station (STA) device in a target overlapping basic service set (OBSS), the first AP device establishes a communication connection with each first STA device, and the target OBSS is an OBSS, which is formed, at a sub-7 GHz frequency band, by means of a plurality of AP devices including the first AP device; and sending the first message frame.

### CROSS-REFERENCE TO RELATED APPLICATION

The application is a U.S. National Stage of International Application No. PCT/CN2022/126540 filed on Oct. 20, 2022, the entire content of which is incorporated herein by reference.

### TECHNICAL FIELD

The embodiments of the present disclosure relate to the technical field of communication, and in particular, the embodiments of the present disclosure relate to a communication method, apparatus, device and storage medium.

### BACKGROUND

With the continuous development of Wireless Fidelity (Wi-Fi) technology, researchers have proposed the next generation of Wi-Fi technology: Ultra High Reliability (UHR). Its vision is to improve the reliability of WLAN connections, reduce latency, improve manageability, increase system throughput, and reduce the power consumption of corresponding devices. UHR technology can enable device communication at least in the sub-7 GHz frequency band. When devices need to communicate with high throughput, they can communicate simultaneously in the sub-7 GHz frequency band, 45 GHz frequency band, and 60 GHz frequency band.

### SUMMARY

The embodiments of the present disclosure provide a communication method, apparatus, a device, and a storage medium.

In a first aspect, an embodiment of the present disclosure provides a communication method, which can be applied to a first AP device, the method including:
determining a first message frame, where the first message frame includes first communication information, the first communication information includes a first communication time period during which the first AP device communicates with at least one first station (STA) device in a target overlapping basic service set (OBSS), the first AP device establishes a communication connection with each of the first STA device, and the target OBSS is an OBSS formed in a sub-7 GHz frequency band by a plurality of AP devices including the first AP device; and
sending the first message frame.

In a second aspect, an embodiment of the present disclosure provides a communication method, which can be applied to a second AP device, the method including:
receiving a first message frame, where the first message frame includes first communication information, the first communication information includes a first communication time period during which a first AP device communicates with at least one first STA device in a target OBSS, a communication connection is established between the first AP device and each of the first STA device, the target OBSS is an OBSS formed in a sub-7 GHz frequency band by a plurality of AP devices including the first AP device, and the second AP device is any AP device corresponding to the target OBSS except the first AP device.

In a third aspect, an embodiment of the present disclosure further provides a communication apparatus, the apparatus including:
a determining unit, configured to determine a first message frame, where the first message frame includes first communication information, the first communication information includes a first communication time period during which a first AP device communicates with at least one first station (STA) device in a target overlapping basic service set (OBSS), a communication connection is established between the first AP device and each of the first STA device, and the target OBSS is an OBSS formed in a sub-7 GHz frequency band by a plurality of AP devices including the first AP device; and
a first transceiver unit, configured to send the first message frame.

In a fourth aspect, an embodiment of the present disclosure further provides a communication apparatus, the apparatus including:
a second transceiver unit, configured to receive a first message frame, where the first message frame includes first communication information, the first communication information includes a first communication time period during which a first AP device communicates with at least one first STA device in a target OBSS, a communication connection is established between the first AP device and each of the first STA device, the target OBSS is an OBSS formed in a sub-7 GHz frequency band by a plurality of AP devices including the first AP device, and the second AP device is any AP device corresponding to the target OBSS except the first AP device.

In a fifth aspect, an embodiment of the present disclosure further provides an AP device, including a memory, a processor, and a computer program stored in the memory and executable on the processor, where when the processor executes the program, the communication method provided in the first aspect or the second aspect of the embodiments of the present disclosure is implemented.

In a sixth aspect, an embodiment of the present disclosure further provides a computer-readable storage medium, on which a computer program is stored, and when the computer program is executed by a processor, any one of the communication methods provided in the embodiments of the present disclosure is implemented.

Additional aspects and advantages of the embodiments of the present disclosure will be partially given in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the drawings required for use in the description of the embodiments of the present disclosure will be briefly introduced below. Obviously, the drawings in the following description are only some embodiments of the present disclosure. For the person skilled in the art, other drawings can be obtained based on these drawings without paying creative labor.

FIG. 1 is a schematic diagram of a flowchart of a communication method provided by an embodiment of the present disclosure;

FIG. 2 is a first schematic diagram of a first example of an embodiment of the present disclosure;

FIG. 3 is a second schematic diagram of the first example of the embodiment of the present disclosure;

FIG. 4 is a schematic diagram of a scenario of an OBSS provided by an embodiment of the present disclosure;

FIG. 5 is another schematic diagram of a flowchart of a communication method provided by an embodiment of the present disclosure;

FIG. 6 is a schematic diagram of a structure of a communication apparatus provided in an embodiment of the present disclosure;

FIG. 7 is another schematic diagram of the structure of the communication apparatus provided in an embodiment of the present disclosure; and

FIG. 8 is a schematic diagram of a structure of an electronic device provided by an embodiment of the present disclosure.

### DETAILED DESCRIPTION

The term “and/or” in the embodiments of the present disclosure describes the association relationship of associated objects, indicating that three relationships may exist. For example, A and/or B may represent three situations: A exists alone, A and B exist at the same time, and B exists alone. The character “/” generally indicates that the associated objects before and after are in an “or” relationship.

The term “plurality” in the embodiments of the present disclosure refers to two or more than two, and other quantifiers are similar thereto.

Exemplary embodiments will be described in detail herein, examples of which are shown in the accompanying drawings. Unless otherwise indicated, the same numbers in different drawings represent the same or similar elements when the following description refers to the drawings. The implementations described in the following exemplary embodiments do not represent all implementations consistent with the present disclosure. Instead, they are merely examples of apparatuses and methods consistent with some aspects of the present disclosure as detailed in the appended claims.

The terms used in the present disclosure are for the purpose of describing specific embodiments only and are not intended to limit the present disclosure. The singular forms “a/an”, “said” and “the” used in the present disclosure and the appended claims are also intended to include plural forms unless the context clearly indicates otherwise. It should also be understood that the term “and/or” used herein refers to and includes any or all possible combinations of one or more associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at the time of” or “when” or “in response to determining”.

Multiple access point (AP) devices may form an Overlapping Basic Service Set (OBSS) in the sub-7 GHz frequency band. When one AP device communicates with one STA device in the OBSS that has established a communication connection with the AP device, other AP device(s) cannot communicate with the STA device in the OBSS that has established a communication connection with the AP device. Therefore, it is necessary to coordinate the communication between each AP device and the STA device in the OBSS.

The following will clearly and completely describe the technical solutions in the embodiments of the present disclosure in combination with the drawings in the embodiments of the present disclosure. Obviously, the described embodiments are only part of the embodiments of the present disclosure, not all of the embodiments. Based on the embodiments in the present disclosure, all other embodiments obtained by the person skilled in the art without making creative work are within the scope of protection of the present disclosure.

The method and the apparatus are based on the same disclosed concept. Since the principles of solving problems by the method and the apparatus are similar, the implementation of the apparatus and the method may refer to each other, and the repeated parts will not be given.

The AP device may be a wireless switch for a wireless network and also an access device of the wireless network. The AP device may include a software application and/or circuit so that other types of nodes in the wireless network can communicate with the outside and inside of the wireless network through the AP device. As an example, the AP device may be a terminal device or a network device equipped with a Wi-Fi chip.

The STA device may specifically include but is not limited to: a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

The embodiments of the present disclosure provide a communication method, apparatus, a device, and a storage medium, which can coordinate the communication between various AP devices and the STA device in the OBSS.

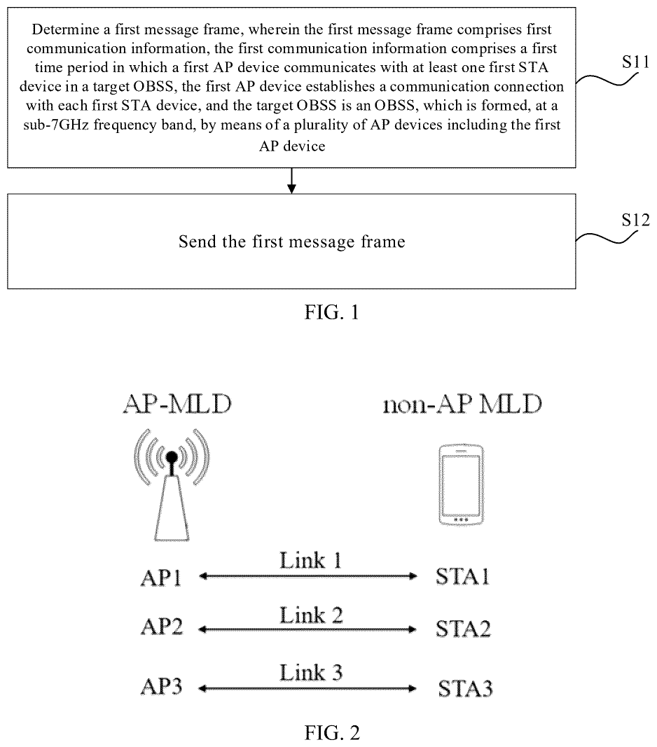

The communication method provided in an embodiment of the present disclosure can be applied to a first AP device. FIG. 1 may be referred to for details. FIG. 1 is a flowchart of a communication method provided in an embodiment of the present disclosure.

Optionally, the method may include the following steps.

In step S11, a first message frame is determined, where the first message frame includes first communication information, the first communication information includes a first time period during which a first AP device communicates with at least one first STA device in a target OBSS, the first AP device establishes a communication connection with each first STA device, and the target OBSS is an OBSS formed by a plurality of AP devices including the first AP device in a sub-7 GHz frequency band.

The first STA device is a STA device in the target OBSS that has established a communication connection with the first AP device, that is, for the first AP device, each STA device in the target OBSS that has established a communication connection with the first AP device is the first STA device in the target OBSS.

Each AP device forms its own Basic Service Set (BSS) within the sub-7 GHz frequency band. When the BSSs of the plurality of AP devices overlap, the overlapping part is determined as the OBSS.

In a wireless LAN, one Basic Service Set (BSS) may be composed of an AP and one or more stations (STAs) communicating with the AP. One Basic Service Set may be connected to a Distribution System (DS) through its AP, and then access to another Basic Service Set to form an Extended Service Set (ESS).

Optionally, the AP is a device with wireless to wired bridging function, and is responsible for extending the service provided by the wired network to the wireless network; STA is an electronic device with wireless network access function, and provides frame delivery service to enable information to be transmitted.

In the embodiments of the present disclosure, the AP and the STA may be devices supporting multi-connection, for example, they may be represented as AP MLD and non-AP MLD, respectively. For ease of description, the following mainly describes an example in which one AP communicates with one STA under multi-connection, however, the exemplary embodiments of the present disclosure are not limited thereto.

In the embodiments of the present disclosure, the first AP is subordinate to the first AP MLD, the second AP is subordinate to the second AP MLD, and the first AP MLD and the second AP MLD are different.

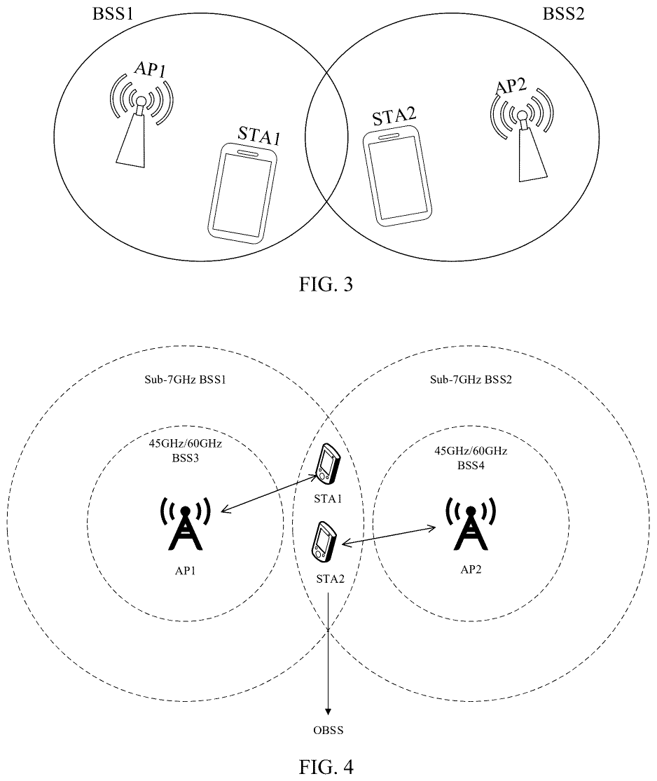

As a first example, referring to FIG. 2 and FIG. 3, the AP MLD may represent an access point supporting a multi-connection communication function, and the non-AP MLD may represent a station supporting a multi-connection communication function.

Referring to FIG. 2, the AP MLD may include three subordinate APs, such as AP1, AP2 and AP3 as shown in FIG. 2; each AP may work in connection 1, connection 2 and connection 3 respectively. The non-AP MLD may also include three subordinate STAs, such as STA1, STA2 and STA3 as shown in FIG. 2; STA1 works in connection 1, STA2 works in connection 2 and STA3 works in connection 3. In FIG. 3, AP1 and STA1 constitute BSS1, and AP2 and STA2 constitute BSS2. In the example of FIG. 2, it is assumed that AP1 communicates with STA1 through the corresponding first connection Link 1, similarly, AP2 communicates with STA2 through the corresponding second connection Link 2, and AP3 communicates with STA3 through the third connection Link 3. In addition, Link 1 to Link 3 may be multiple connections at different frequencies, for example, connections at 2.4 GHz, 5 GHz, 6 GHz, or several connections of the same or different bandwidths at 2.4 GHz. In addition, multiple channels may exist under each connection. It may be understood that the communication scenario shown in FIG. 2 is merely exemplary and the concept of the present disclosure is not limited thereto. For example, the AP MLD may be connected to multiple (three) non-AP MLDs, or in each connection, the AP may communicate with multiple other types of station devices.

As shown in FIG. 4, FIG. 4 is a schematic diagram of the OBSS scenario provided by an embodiment of the present disclosure. AP device 1 forms BSS1 within the sub-7 GHz frequency band, AP device 2 forms BSS2 within the sub-7 GHz frequency band, and the overlapping part of BSS1 and BSS2 is the target OBSS. AP device 1 and AP device 2 form BSS3 and BSS4 within the 45 GHz frequency band or the 60 GHz frequency band, respectively, and BSS3 and BSS4 do not overlap.

STA1 and STA2 are both located in the target OBSS, and STA1 has established a communication connection with AP device 1, and STA2 has established a communication connection with AP device 2. If AP device 1 is the first AP device, STA1 is the first STA device. If AP device 2 is the first AP device, STA2 is the first STA device.

The first communication information includes a first communication time period during which the first AP device communicates with at least one first STA device in the target OBSS, and may also include other relevant information such as the communication link when the first AP device communicates with at least one STA device in the target OBSS, which is not limited here.

When the first AP device needs to coordinate the communication between the AP devices corresponding to the target OBSS and the corresponding STA devices in the target OBSS, the first AP device may determine a first message frame to send to other AP device(s) corresponding to the target OBSS the first communication time period of the first AP device and at least one first STA device in the target OBSS with which a communication connection is established.

The sub-7 GHz frequency band can specifically support 2.4 GHz frequency band, 5 GHz frequency band and 6 GHz frequency band.
In step S12: the first message frame is sent.

After the first message frame is determined, the first message frame may be sent to other AP device(s) corresponding to the target OBSS.

In the communication method applied to the first AP device provided in the present disclosure, the first message frame may be a management frame, for example, it may be a communication resource coordination frame.

In the communication method applied to the first AP device provided in the present disclosure, each first communication time period in the first communication information is used to indicate that each AP device corresponding to the target OBSS except the first AP device does not communicate with the second STA device with which a communication connection has been established in the target OBSS during the corresponding first communication time period, and each second STA device does not establish a communication connection with the first AP device.

The target OBSS includes a first STA device and a second STA device, the first STA device is a STA device that has established a communication connection with the first AP device, and the second STA device is a STA device that has not established a communication connection with the first AP device.

As an example, the target OBSS includes STA1, STA2 and STA3, and STA1 and STA3 only establish communication connections with AP device 1, and STA2 only establishes a communication connection with AP device 2. The target OBSS is an OBSS formed by AP device 1 and AP device 2 within the sub-7 GHz frequency band.

AP device 1 sends a first message frame, the first message frame includes first communication information, the first communication information includes a first communication time period for communication between AP device 1 and STA1, and a first communication time period for communication between AP device 1 and STA3. Then, the first communication time period for communication between AP device 1 and STA1 is used to indicate that AP device 2 does not communicate with STA2 during this first communication time period. The first communication time period for communication between AP device 1 and STA3 is used to indicate that AP device 2 does not communicate with STA2 during this first communication time period.

In the communication method applied to the first AP device provided in the present disclosure, each first communication time period in the first communication information is also used to indicate that each AP device corresponding to the target OBSS except the first AP device is allowed to communicate with a third STA device with which a communication connection has been established in the 45 GHz frequency band and/or the 60 GHz frequency band within the corresponding first communication time period.

For each AP device corresponding to the target OBSS except the first AP device, the STA device that has established a communication connection with the AP device in the 45 GHz frequency band and/or the 60 GHz frequency band is the third STA device.

As an example, the target OBSS includes STA1 and STA2, and STA1 only establishes a communication connection with AP device 1, and STA2 only establishes a communication connection with AP device 2. The target OBSS is an OBSS formed by AP device 1 and AP device 2 within the sub-7 GHz frequency band.

AP device 1 sends a first message frame, the first message frame includes first communication information, and the first communication information includes a first communication time period for communication between AP device 1 and STA1. If the STA device with which AP device 2 has established a communication connection in the 45 GHz frequency band and/or the 60 GHz frequency band is STA3, the first communication time period for communication between AP device 1 and STA1 is also used to indicate that AP device 2 is allowed to communicate with STA3 in this first communication time period.

In the communication method applied to the first AP device provided in the present disclosure, each first communication time period in the first communication information is also used to indicate that each AP device corresponding to the target OBSS except the first AP device is allowed to communicate with a fourth STA device within the corresponding first communication time period.

The fourth STA device corresponding to each AP device corresponding to the target OBSS except the first AP device is a STA device of this AP device in the sub-7 GHz frequency band and outside the target OBSS.

As an example, the target OBSS includes STA1 and STA2, and STA1 only establishes a communication connection with AP device 1, and STA2 only establishes a communication connection with AP device 2. The target OBSS is an OBSS formed by AP device 1 and AP device 2 within the sub-7 GHz frequency band, and AP device 2 also includes STA4 within the sub-7 GHz frequency band.

AP device 1 sends a first message frame, which includes first communication information. The first communication information includes a first communication time period for communication between AP device 1 and STA1. The first communication time period is also used to indicate that AP device 2 is allowed to communicate with STA4 within the sub-7 GHz frequency band.

In the communication method applied to the first AP device provided in the present disclosure, the method further includes:
sending a Time Sync Function (TSF) parameter. The TSF parameter is used to perform time synchronization (clock synchronization) with other AP device(s) corresponding to the target OBSS except the first AP device.

The first AP device may send the TSF parameter to other AP device(s) corresponding to the target OBSS through a wired link for time synchronization. That is, the first AP device may perform time synchronization with other AP device(s) corresponding to the target OBSS through a wired time synchronization mechanism.

The first AP device may send the TSF parameter to other AP device(s) corresponding to the target OBSS via a wireless link for time synchronization. That is, the first AP device may perform time synchronization with other AP device(s) corresponding to the target OBSS via a wireless air interface time synchronization mechanism.

The first AP device maintains time synchronization with other AP device(s) corresponding to the target OBSS, which can ensure that each AP device corresponding to the target OBSS except the first AP device does not communicate with the second STA device with which a communication connection has been established in the target OBSS during each first communication time period included in the first communication information.

In the communication method applied to the first AP device provided in the present disclosure, the method further includes:
receiving second communication information sent by each AP device corresponding to the target OBSS except the first AP device, where each second communication information includes a second time period for the corresponding AP device to communicate with the STA device with which the communication connection has been established.

For each AP device corresponding to the target OBSS except the first AP device, the second communication information sent by the AP device may include a second communication time period for the AP device to communicate with a STA device in the target OBSS with which a communication connection has been established with the AP device, and may also include a second communication time period for the AP device to communicate with a STA device with which a communication connection has been established within the sub-7 GHz frequency band, and may also include a second communication time period for the AP device to communicate with a STA device with which a communication connection has been established within the 45 GHz frequency band and/or 60 GHz frequency band, which is not limited here.

For the first AP device, the first AP device can adjust the communication time period for the first AP device to communicate with the first STA device with which an association has been established in the target OBSS according to the second communication time period for other AP device(s) corresponding to the target OBSS to communicate with the STA device with which the communication connection has been established.

The second communication information sent by each AP device may also include other relevant information such as the communication link when the AP device communicates with the corresponding STA device, and each second communication time period may be an uplink and downlink communication time period between the corresponding AP device and the corresponding STA device.

In the communication method applied to the first AP device provided in the present disclosure, the method further includes:
receiving third communication information sent by each STA device that has established a communication connection with the first AP device, where each third communication information includes a third communication time period for the corresponding STA device to communicate with the first AP device.

The first AP device may receive the third communication information sent by the first STA device that has established a communication connection with the first AP device in the target OBSS, and may also receive the third communication information sent by the STA device that has established a communication connection within the sub-7 GHz frequency band, and may also receive the third communication information sent by the STA device that has established a communication connection within the 45 GHz frequency band and/or 60 GHz frequency band, which is not limited here.

The third communication information sent by each STA device may also include other relevant information such as the communication link when the STA device communicates with the first AP device, and each third communication time period may specifically be a communication time period for uplink communication between the STA device and the first AP device.

For the first AP device, the first AP device may determine the first communication time period for the first AP device to communicate with each first STA device with which it has established a communication association in the target OBSS by receiving the third communication information sent by each STA device with which the communication connection has been established, and then send the first message frame.

In the communication method applied to the first AP device provided in the present disclosure, the method further includes:
determining a second message frame, where the second message frame includes a first identification bit, and the first identification bit is used to indicate the first AP device to send the first message frame; and
sending the second message frame.

The first AP device that sends the first message frame is a master AP device, and other AP device(s) corresponding to the target OBSS is a slave AP device(s). When the master AP device communicates with the STA device that establishes a communication connection with this master AP device in the target OBSS, the slave AP device does not communicate with the STA device that establishes a communication connection with this slave AP device in the target OBSS, but may communicate with the STA device that has established a communication connection within the 45 GHz frequency band and/or the 60 GHz frequency band.

For the first AP device, the first AP device may send a second message frame, and indicate through the first identification bit in the second message frame that it is about to send the first message frame, that is, it is used to indicate that the first AP device is the master AP device.

The first AP device may send the second message frame to other AP device(s) corresponding to the target OBSS via a wired link or a wireless link.

The first identification bit may indicate that the first AP device is a master AP device through a first value.

That is, all AP devices corresponding to the target OBSS can negotiate the master AP device through a wired link or a wireless link. Specifically, each AP device corresponding to the target OBSS can send a second message frame to other AP device(s). When the identification value of the first identification bit in any second message frame is the first value, it indicates that the corresponding AP device is the master AP device, that is, the first AP device. When the identification value of the second identification bit in the second message frame is a second value, it indicates that the corresponding AP device is a slave AP device.

Optionally, the first identification bit may also be used to indicate the identification bit of the TSF parameter. That is, after the first AP device sends the second message frame including the TSF parameter to other AP device(s) corresponding to the target OBSS, the first AP device is indicated as the master AP device and then the first message frame is sent.

That is, for all AP device(s) corresponding to the target OBSS, the AP device that first sends the second message frame including the first identification bit for indicating the TSF parameter is the master AP device, and it sends the first message frame as the first AP device in the embodiments of the present disclosure.

In the communication method applied to the second AP device provided in the present disclosure, the first message frame sent by the first AP device may be a beacon frame or a probe response frame.

In the communication method applied to the second AP device provided in the present disclosure, the second message frame includes an extended capabilities information element, and the extended capabilities information element includes a first identification bit.

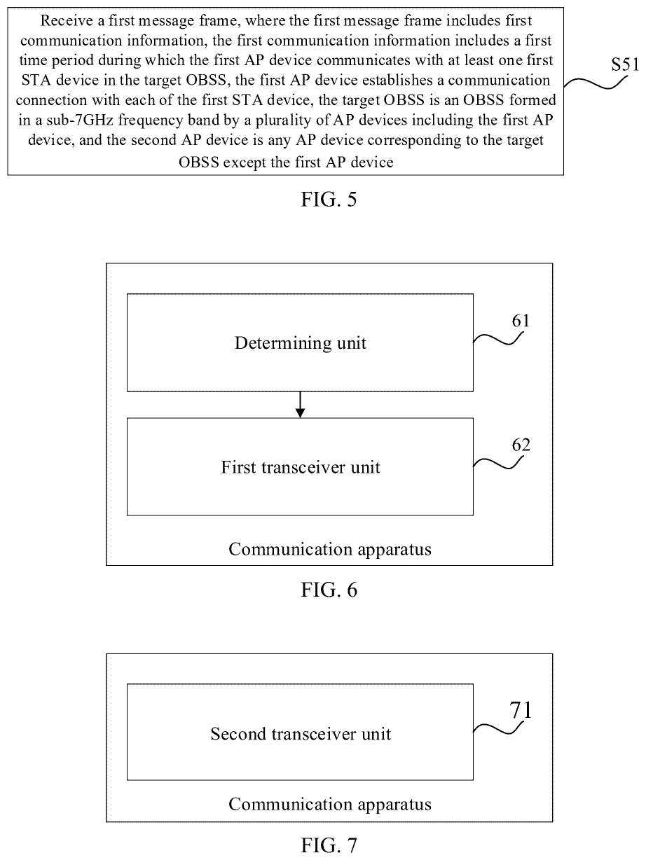

A communication method provided in an embodiment of the present disclosure may be applied to a second AP device. For details, FIG. 5 may be referred to, which is another flowchart of the communication method provided in an embodiment of the present disclosure.

Optionally, the method may include the following steps.

In step S51, a first message frame is received, where the first message frame includes first communication information, the first communication information includes a first time period for the first AP device to communicate with at least one first STA device in the target OBSS, the first AP device establishes a communication connection with each of the first STA device, the target OBSS is an OBSS formed in the sub-7 GHz frequency band by a plurality of AP devices including the first AP device, and the second AP device is any AP device corresponding to the target OBSS except the first AP device.

The first STA device is a STA device in the target OBSS that has established a communication connection with the first AP device, that is, for the first AP device, each STA device in the target OBSS that has established a communication connection with the first AP device is the first STA device in the target OBSS.

Each AP device forms its own BSS within the sub-7 GHz frequency band. When the BSSs of a plurality of AP devices overlap, the overlapping part is determined as OBSS.

The second AP device may be subordinate to any AP MLD.

As shown in FIG. 4, AP device 1 forms BSS1 in the sub-7 GHz frequency band, and AP device 2 forms BSS2 in the sub-7 GHz frequency band. The overlapping part of BSS1 and BSS2 is the target OBSS. AP device 1 and AP device 2 form BSS3 and BSS4 in the 45 GHz frequency band or 60 GHz frequency band respectively, and BSS3 and BSS4 do not overlap.

STA1 and STA2 are both located in the target OBSS, and STA1 has established a communication connection with AP device 1, and STA2 has established a communication connection with AP device 2. If AP device 1 is the first AP device, STA1 is the first STA device, and AP device 2 may be the second AP device. If AP device 2 is the first AP device, STA2 is the first STA device, and AP device 1 may be the second AP device.

The first communication information includes a first communication time period during which the first AP device communicates with at least one first STA device in the target OBSS, and may also include other relevant information such as the communication link when the first AP device communicates with at least one STA device in the target OBSS, which is not limited here.

The first message frame is determined by the first AP device when it is necessary to coordinate the communication between each AP device corresponding to the target OBSS and the corresponding STA device in the target OBSS.

For the second AP device, the second AP device may receive the first message frame sent by the first AP device.

The sub-7 GHz frequency band may specifically support the 2.4 GHz frequency band, 5 GHz frequency band and 6 GHz frequency band.

In the communication method applied to the second AP device provided in the present disclosure, the first message frame may be a management frame, such as a communication resource coordination frame.

In the communication method applied to the second AP device provided in the present disclosure, each first communication time period in the first communication information is used to indicate that each AP device corresponding to the target OBSS except the first AP device does not communicate with the second STA device with which a communication connection has been established in the target OBSS during the corresponding first communication time period, and each second STA device does not establish a communication connection with the first AP device.

The target OBSS includes a first STA device and a second STA device, the first STA device is a STA device that has established a communication connection with the first AP device, and the second STA device is a STA device that has not established a communication connection with the first AP device.

As an example, the target OBSS includes STA1, STA2 and STA3, and STA1 and STA3 only establish communication connections with AP device 1, and STA2 only establishes a communication connection with AP device 2. The target OBSS is an OBSS formed by AP device 1 and AP device 2 within the sub-7 GHz frequency band.

AP device 2 receives the first message frame as a second AP device, the first message frame includes first communication information, the first communication information includes a first communication time period for communication between AP device 1 and STA1, and a first communication time period for communication between AP device 1 and STA3. The first communication time period for communication between AP device 1 and STA1 is used to indicate that AP device 2 does not communicate with STA2 during the first communication time period. The first communication time period for communication between AP device 1 and STA3 is used to indicate that AP device 2 does not communicate with STA2 during the first communication time period.

In the communication method applied to the second AP device provided in the present disclosure, each first communication time period in the first communication information is also used to indicate that each AP device corresponding to the target OBSS except the first AP device is allowed to communicate with a third STA device with which a communication connection has been established in the 45 GHz frequency band and/or the 60 GHz frequency band within the corresponding first communication time period.

For each AP device corresponding to the target OBSS except the first AP device, the STA device that has established a communication connection with the AP device in the 45 GHz frequency band and/or the 60 GHz frequency band is the third STA device.

As an example, the target OBSS includes STA1 and STA2, and STA1 only establishes a communication connection with AP device 1, and STA2 only establishes a communication connection with AP device 2. The target OBSS is an OBSS formed by AP device 1 and AP device 2 within the sub-7 GHz frequency band.

AP device 2 receives the first message frame as a second AP device, the first message frame includes first communication information, and the first communication information includes a first communication time period for communication between AP device 1 and STA1. If the STA device with which AP device 2 has established a communication connection in the 45 GHz frequency band and/or the 60 GHz frequency band is STA3, the first communication time period for communication between AP device 1 and STA1 is also used to indicate that AP device 2 is allowed to communicate with STA3 in the first communication time period.

In the communication method applied to the second AP device provided in the present disclosure, each first communication time period in the first communication information is also used to indicate that each AP device corresponding to the target OBSS except the first AP device is allowed to communicate with a fourth STA device within the corresponding first communication time period.

The fourth STA device corresponding to each AP device corresponding to the target OBSS except the first AP device is a STA device of the AP device in the sub-7 GHz frequency band and outside the target OBSS.

As an example, the target OBSS includes STA1 and STA2, and STA1 only establishes a communication connection with AP device 1, and STA2 only establishes a communication connection with AP device 2. The target OBSS is an OBSS formed by AP device 1 and AP device 2 within the sub-7 GHz frequency band, and AP device 2 also includes STA4 within the sub-7 GHz frequency band.

AP device 2 receives the first message frame as a second AP device. The first message frame includes first communication information. The first communication information includes a first communication time period for communication between AP device 1 and STA1. The first communication time period is also used to indicate that AP device 2 is allowed to communicate with STA4 within the sub-7 GHz frequency band.

In the communication method applied to the second AP device provided in the present disclosure, the method further includes:
receiving a TSF parameter. When the first AP device sends the TSF parameter, the TSF parameter is used to perform time synchronization with other AP device(s) corresponding to the target OBSS except the first AP device. When the second AP device receives the TSF parameter, the second AP device may perform time synchronization with the first AP device based on the TSF parameter.

The second AP device may receive the TSF parameter sent by the first AP device via a wired link to perform time synchronization with the first AP device, that is, the second AP device may perform time synchronization with the first AP device via a wired time synchronization mechanism.

The second AP device may receive the TSF parameter sent by the first AP device via a wireless link to perform time synchronization with the first AP device, that is, the second AP device may perform time synchronization with the first AP device via a wireless air interface time synchronization mechanism.

The second AP device can ensure that the second AP device does not communicate with the second STA device with which a communication connection has been established in the target OBSS during each first communication time period included in the first communication information by maintaining time synchronization with the first AP device.

In the communication method applied to the second AP device provided in the present disclosure, the method further includes:
sending second communication information, where each second communication information includes a second time period during which the second AP device communicates with the STA device with which the communication connection has been established.

The second communication information sent by the second AP device may include a second communication time period for the second AP device to communicate with a STA device in the target OBSS with which a communication connection has been established with the second AP device, may also include a second communication time period for the second AP device to communicate with a STA device with which a communication connection has been established within a sub-7 GHz frequency band, and may also include a second communication time period for the second AP device to communicate with a STA device with which a communication connection has been established within a 45 GHz frequency band and/or a 60 GHz frequency band, which is not limited here.

After the second AP device sends the second communication information to the first AP device, the first AP device can adjust the communication time period for the first AP device to communicate with the first STA device with which it has established an association in the target OBSS according to the second communication time period for the second AP device to communicate with the STA device with which it has established a communication connection.

The second communication information sent by the second AP device may also include other relevant information such as the communication link when the second AP device communicates with the corresponding STA device, and each second communication time period may be an uplink and downlink communication time period between the second AP device and the corresponding STA device.

In the communication method applied to the second AP device provided in the present disclosure, the method further includes:
receiving fourth communication information sent by each STA device that has established a communication connection with the second AP device, where each fourth communication information includes a fourth communication time period for the corresponding STA device to communicate with the first AP device.

The second AP device can receive the third communication information sent by the STA device in the target OBSS that has established a communication connection with the second AP device, and can also receive the fourth communication information sent by the STA device that has established a communication connection within the sub-7 GHz frequency band, and can also receive the fourth communication information sent by the STA device that has established a communication connection within the 45 GHz frequency band and/or the 60 GHz frequency band, which is not limited here.

The fourth communication information sent by each STA device may also include other relevant information such as the communication link when the STA device communicates with the second AP device, and each fourth communication time period may specifically be a communication time period for uplink communication between the STA device and the second AP device.

The second AP device may determine the second time period for communication with the corresponding STA device by receiving the fourth communication information sent by each STA device that has established a communication connection.

In the communication method applied to the second AP device provided in the present disclosure, the method further includes:
receiving a second message frame, where the second message frame includes a first identification bit, and the first identification bit is used to indicate the first AP device to send the first message frame;
where the first AP device that sends the first message frame is the master AP device, and other AP device(s) corresponding to the target OBSS is a slave AP device. When the master AP device communicates with the STA device that establishes a communication connection with the master AP device in the target OBSS, the slave AP device does not communicate with the STA device that establishes a communication connection with the slave AP device in the target OBSS, but can communicate with the STA device that has established a communication connection within the 45 GHz frequency band and/or the 60 GHz frequency band.

For the second AP device, the second AP device receives the second message frame and determines through the first identification bit in the second message frame that the first AP device is going to send the first message frame, that is, it is determined that the first AP device is the master AP device.

The second AP device may receive the second message frame sent by the first AP device via a wired link or a wireless link.

The first identification bit may indicate that the first AP device is a master AP device through a first value.

That is, all AP devices corresponding to the target OBSS can negotiate the master AP device through a wired link or a wireless link. Specifically, each AP device corresponding to the target OBSS can send a second message frame to other AP device(s). When the identification value of the first identification bit in any second message frame is the first value, it indicates that the corresponding AP device is the master AP device, that is, the first AP device. When the identification value of the second identification bit in the second message frame is a second value, it indicates that the corresponding AP device is a slave AP device.

Optionally, the first identification bit may also be used to indicate the identification bit of the TSF parameter. That is, after the second AP device receives the second message frame including the TSF parameter sent by any other AP device corresponding to the target OBSS, it can determine that the AP device sending the second message frame is the master AP device, and further determine that the AP device sends the first message frame thereafter as the first AP device.

That is, for all AP devices corresponding to the target OBSS, the AP device that first sends the second message frame including the first identification bit for indicating the TSF parameter is the master AP device, and it sends the first message frame as the first AP device in the embodiment of the present disclosure. The AP device that does not send the second message frame for indicating the first identification bit of the TSF parameter is the slave AP device, and it receives the first message frame as the second AP device in the embodiment of the present disclosure.

In the communication method applied to the second AP device provided in the present disclosure, the first message frame received by the second AP device may be a beacon frame or a probe response frame.

In the communication method applied to the second AP device provided in the present disclosure, the second message frame received by the second AP device includes an extended capabilities information element, and the extended capabilities information element includes a first identification bit.

The embodiments of the present disclosure provide a method for coordinating the AP devices corresponding to the OBSS to communicate with the corresponding STA devices in the OBSS when a plurality of AP devices form an OBSS within a sub-7 GHz frequency band.

The embodiment of the present disclosure further provides a communication method, which can be applied to a third AP device, including:
receiving a first wireless frame, where the first wireless frame includes a first time period in which a fourth AP communicates with a first station STA device using a first frequency band (e.g., a sub-7 GHz frequency band); where the fourth AP is associated with the first STA, and the third AP and the fourth AP form an overlapping basic service set (OBSS) in the first frequency band;
determining not to communicate with the first STA device using the first frequency band in the first time period.

Optionally, in the embodiment of the present disclosure, determining not to communicate with the first STA device in the first time period using the first frequency band includes any one of the following:
determining to communicate with the first STA device using the first frequency band in a second time period, where the second time period does not overlap with the first time period;
alternatively, determining to communicate with the first STA device using a second frequency band (such as a 45 GHz frequency band and/or a 60 GHz frequency band) in a third time period, where the third time period overlaps or does not overlap with the first time period.

Optionally, in the embodiments of the present disclosure, the third AP and the fourth AP do not form an OBSS in the second frequency band.

Optionally, in the embodiments of the present disclosure, the method further includes:
sending a second wireless frame, where the second wireless frame includes a fourth time period in which the third AP and the first STA device use the first frequency band; the second wireless frame is used to notify other AP(s) that form an OBSS with the third AP not to communicate with the first STA using the first frequency band in the fourth time period.

Optionally, in the embodiments of the present disclosure, the method further includes:
sending a time sync function (TSF) parameter, where the TSF parameter is used to perform time synchronization with the fourth AP.

The embodiment of the present disclosure further provides a communication method, which can be applied to a fourth AP device, including:
sending a first wireless frame, where the first wireless frame includes a first time period in which the fourth AP communicates with the first station (STA) device using the first frequency band; where the fourth AP is associated with the first STA, and the first time period is used to indicate that the third AP does not communicate with the first STA device using the first frequency band during the first time period, and the third AP and the fourth AP form an overlapping basic service set (OBSS) in the first frequency band.

Optionally, in the embodiments of the present disclosure, the third AP not communicating with the first STA device using the first frequency band in the first time period includes any of the following:
the third AP communicating with the first STA device using the first frequency band in a second time period, where the second time period does not overlap with the first time period;
alternatively, the third AP communicating with the first STA device using the second frequency band in a third time period, where the third time period overlaps or does not overlap with the first time period.

Optionally, in the embodiments of the present disclosure, the third AP and the fourth AP do not form an OBSS in the second frequency band.

Optionally, in the embodiments of the present disclosure, the method further includes:
receiving a second wireless frame, where the second wireless frame includes a fourth time period in which the third AP and the first STA device use the first frequency band;
determining not to communicate with the first STA using the first frequency band in the fourth time period.

Optionally, in the embodiments of the present disclosure, the method further includes:
sending a time sync function (TSF) parameter, where the TSF parameter is used to perform time synchronization with the third AP.

As shown in FIG. 6, an embodiment of the present disclosure provides a communication apparatus, including:
a determining unit 61, configured to determine a first message frame, where the first message frame includes first communication information, the first communication information includes a first communication time period during which the first AP device communicates with at least one first station (STA) device in a target overlapping basic service set (OBSS), a communication connection is established between the first AP device and each of the first STA device, and the target OBSS is an OBSS formed by a plurality of AP devices including the first AP device in a sub-7 GHz frequency band;
a first transceiver unit 62, configured to send the first message frame.

Optionally, in an embodiment of the present disclosure, each of the above-mentioned first communication time period is used to indicate that each AP device corresponding to the above-mentioned target OBSS except the above-mentioned first AP device does not communicate with the second STA device with which a communication connection has been established in the above-mentioned target OBSS during the corresponding first communication time period, and each of the above-mentioned second STA devices does not establish a communication connection with the above-mentioned first AP device.

Optionally, in an embodiment of the present disclosure, each of the above-mentioned first communication time periods is also used to indicate that each AP device corresponding to the above-mentioned target OBSS except the above-mentioned first AP device is allowed to communicate with a third STA device that has established a communication connection in the 65 GHz frequency band and/or the 60 GHz frequency band within the corresponding first communication time period.

Optionally, in the embodiment of the present disclosure, the first transceiver unit 62 is further configured to:
send a time sync function (TSF) parameter, where the TSF parameter is used to perform time synchronization with other AP device(s) corresponding to the target OBSS.

Optionally, in the embodiment of the present disclosure, the first transceiver unit 62 is further configured to:
receive second communication information sent by each AP device corresponding to the target OBSS except the first AP device, where each of the above-mentioned second communication information includes a second communication time period for the corresponding AP device to communicate with the STA device with which the communication connection has been established.

Optionally, in the embodiment of the present disclosure, the first transceiver unit 62 is further configured to:
receive third communication information sent by each STA device that has established a communication connection with the first AP device, where each of the third communication information includes a third communication time period for the corresponding STA device to communicate with the first AP device.

Optionally, in the embodiment of the present disclosure, the determining unit 61 is further configured to:
determine a second message frame, where the second message frame includes a first identification bit, and the first identification bit is used to indicate the first AP device to send the first message frame;
the first transceiver unit 62 is further configured to:
send the second message frame.

Optionally, in an embodiment of the present disclosure, the first message frame is a beacon frame or a probe response frame.

As shown in FIG. 7, an embodiment of the present disclosure provides a communication apparatus, including:
a second transceiver unit 71, configured to receive a first message frame, where the first message frame includes first communication information, the first communication information includes a first communication time period for the first AP device to communicate with at least one first STA device in a target OBSS, the first AP device establishes a communication connection with each of the first STA device, the target OBSS is an OBSS formed by a plurality of AP devices including the first AP device in the sub-7 GHz frequency band, and the second AP device is any AP device corresponding to the target OBSS except the first AP device.

Optionally, in an embodiment of the present disclosure, each of the above-mentioned first communication time period is used to indicate that each AP device corresponding to the above-mentioned target OBSS except the above-mentioned first AP device does not communicate with the second STA device with which a communication connection has been established in the above-mentioned target OBSS during the corresponding first communication time period, and each of the above-mentioned second STA devices does not establish a communication connection with the above-mentioned first AP device.

Optionally, in an embodiment of the present disclosure, each of the above-mentioned first communication time periods is also used to indicate that each AP device corresponding to the above-mentioned target OBSS except the above-mentioned first AP device is allowed to communicate with a third STA device that has established a communication connection in the 47 GHz frequency band and/or the 70 GHz frequency band within the corresponding first communication time period.

Optionally, in the embodiment of the present disclosure, the second transceiver unit 71 is further configured to:
receive a time sync function (TSF) parameter, where the TSF parameter is used to perform time synchronization with the first AP device.

Optionally, in the embodiment of the present disclosure, the second transceiver unit 71 is further configured to:
send second communication information, where the second communication information includes a second communication time period during which the second AP device communicates with the STA device with which the communication connection has been established.

Optionally, in the embodiment of the present disclosure, the second transceiver unit 71 is further configured to:
receive fourth communication information sent by each STA device that has established a communication connection with the second AP device, where each of the fourth communication information includes a fourth communication time period for the corresponding STA device to communicate with the second AP device.

Optionally, in the embodiment of the present disclosure, the second transceiver unit 71 is further configured to:
receive a second message frame, where the second message frame includes a first identification bit, and the first identification bit is used to indicate the first AP device to send the first message frame.

Optionally, in an embodiment of the present disclosure, the first message frame is a beacon frame or a probe response frame.

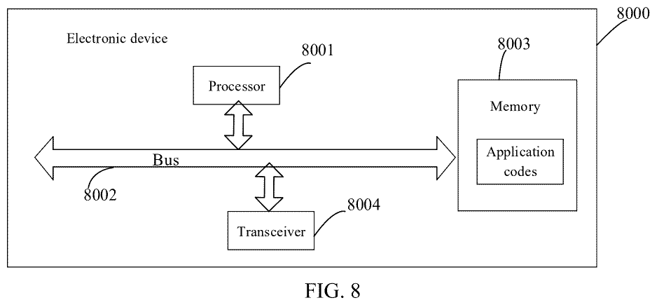

The embodiment of the present disclosure also provides an electronic device, as shown in FIG. 8. The electronic device 8000 shown in FIG. 8 includes: a processor 8001 and a memory 8003. The processor 8001 and the memory 8003 are connected, such as through a bus 8002. Optionally, the electronic device 8000 may further include a transceiver 8004. It should be noted that in actual applications, the transceiver 8004 is not limited to one, and the structure of the electronic device 8000 does not constitute a limitation on the embodiments of the present disclosure.

The memory 8003 is used to store application codes for executing the embodiments of the present disclosure, and the execution is controlled by the processor 8001. When the electronic device 8000 acts as the first AP device, the processor 8001 is used to execute the application codes stored in the memory 8003 to implement the communication method applicable to the first AP device in the present solution. When the electronic device 8000 acts as the second AP device, the processor 8001 is used to execute the application codes stored in the memory 8003 to implement the communication method applicable to the second AP device in the present solution.

The bus 8002 may include a path for transmitting information between the above components. The bus 8002 may be a Peripheral Component Interconnect (PCI) bus or an Extended Industry Standard Architecture (EISA) bus. The bus 8002 may be divided into an address bus, a data bus, a control bus, etc. For ease of representation, it is represented by only one thick line in FIG. 8, but it does not mean that there is only one bus or one type of bus.

The memory 8003 may be a read-only memory (ROM) or other types of static storage devices that can store static information and instructions, a random access memory (RAM) or other types of dynamic storage devices that can store information and instructions, or an electrically erasable programmable read only memory (EEPROM), a compact disc read only memory (CD-ROM) or other optical disc storage, optical disk storage (including compact optical disc, laser disc, optical disc, digital versatile disc, Blu-ray disc, etc.), a magnetic disk storage medium or other magnetic storage device, or any other medium that can be used to carry or store the desired program code in the form of instructions or data structures and can be accessed by a computer, but is not limited thereto.

An embodiment of the present disclosure provides a computer-readable storage medium, on which a computer program is stored. When the computer program is run on a computer, the computer can execute the corresponding contents of the aforementioned method embodiments.

It should be understood that, although the steps in the flowchart of the accompanying drawings are displayed in sequence as indicated by the arrows, these steps are not necessarily executed in the order indicated by the arrows. Unless otherwise specified herein, there is no strict order restriction on the execution of these steps, and they can be executed in other orders. Moreover, at least a part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least a part of the sub-steps or stages of other steps.

It should be noted that the computer-readable storage medium disclosed above may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of the computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that can be used by or in combination with an instruction execution system, apparatus or device. In the present disclosure, the computer-readable signal medium may include a data signal propagated in a baseband or as part of a carrier wave, in which a computer-readable program code is carried. This propagated data signal may take a variety of forms, including but not limited to electromagnetic signals, optical signals, or any suitable combination of the above. The computer readable signal medium may also be any computer readable storage medium other than a computer readable storage medium, which may send, propagate or transmit a program for use by or in conjunction with an instruction execution system, apparatus or device. The program code contained on the computer readable storage medium may be transmitted using any suitable medium, including but not limited to: wires, optical cables, radio frequency (RF), etc., or any suitable combination of the above.

The computer-readable storage medium may be included in the wireless local area network initiating device or responding device; or may exist independently without being assembled into the wireless local area network initiating device or responding device.

The above-mentioned computer-readable storage medium carries one or more programs. When the above-mentioned one or more programs are executed by the first AP device or the second AP device, the first AP device or the second AP device executes the corresponding communication method.

According to one aspect of the present disclosure, a computer program product or a computer program is provided, the computer program product or the computer program including computer instructions, the computer instructions being stored in a computer-readable storage medium. A processor of a computer device reads the computer instructions from the computer-readable storage medium, and the processor executes the computer instructions, so that the computer device executes the communication method provided in the above-mentioned various optional implementations.

The computer program code for performing the operations of the present disclosure may be written in one or more programming languages, or a combination thereof, including object-oriented programming languages, such as Java, Smalltalk, C++, and conventional procedural programming languages, such as “C” or similar programming languages. The program code may be executed entirely on the user's computer, partially on the user's computer, as a separate software package, partially on the user's computer and partially on a remote computer, or entirely on a remote computer or server. In cases involving a remote computer, the remote computer may be connected to the user's computer through any type of network, including a local area network (LAN) or a wide area network (WAN), or may be connected to an external computer (e.g., through the Internet using an Internet service provider).

The flowcharts and block diagrams in the accompanying drawings illustrate the possible architecture, function and operation of the system, method and computer program product according to various embodiments of the present disclosure. In this regard, each square box in the flowcharts or block diagrams can represent a part of a module, a program segment or a code, and a part of the module, the program segment or the code contains one or more executable instructions for realizing the specified logical function. It should also be noted that in some implementations as replacements, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagrams and/or flowcharts, and the combination of the square boxes in the block diagrams and/or flowcharts can be implemented with a dedicated hardware-based system that performs a specified function or operation, or can be implemented with a combination of dedicated hardware and computer instructions.

The modules involved in the embodiments described in the present disclosure may be implemented by software or hardware. The name of a module does not limit the module itself in some cases. For example, module A may also be described as “module A for performing operation B”.

The embodiments of the present disclosure provide a method for coordinating the AP devices corresponding to the OBSS to communicate with the corresponding STA devices in the OBSS when a plurality of AP devices form an OBSS within the sub-7 GHz frequency band.

The above description is only the preferred embodiments of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, the above features are replaced with the technical features with similar functions disclosed in the present disclosure (but not limited to) by each other.

1. A communication method, applied to a first access point (AP) device, the method comprising:
determining a first message frame, wherein the first message frame comprises first communication information, the first communication information comprises a first communication time period during which the first AP device communicates with at least one first station (STA) device in a target overlapping basic service set (OBSS), the first AP device establishes a communication connection with each of the first STA device, and the target OBSS is an OBSS formed in a sub-7 GHz frequency band by a plurality of AP devices comprising the first AP device; and
sending the first message frame.

2. The method according to claim 1, wherein each of the first communication time period is used to indicate that each AP device corresponding to the target OBSS except the first AP device does not communicate with a second STA device with which a communication connection has been established in the target OBSS during a corresponding first communication time period, and each of the second STA device does not establish a communication connection with the first AP device.

3. The method according to claim 1, wherein each of the first communication time period is further used to indicate that each AP device corresponding to the target OBSS except the first AP device is allowed to communicate with a third STA device that has established a communication connection in a 45 GHz frequency band and/or a 60 GHz frequency band during the corresponding first communication time period.

4. The method according to claim 1, wherein the method further comprises:
sending a time sync function (TSF) parameter, wherein the TSF parameter is used to perform time synchronization with other AP device corresponding to the target OBSS.

5. The method according to claim 1, wherein the method further comprises:
receiving second communication information sent by each AP device corresponding to the target OBSS except the first AP device, wherein each of the second communication information comprises a second communication time period during which the corresponding AP device communicates with a STA device with which a communication connection has been established.

6. The method according to claim 1, wherein the method further comprises:
receiving third communication information sent by each STA device that has established a communication connection with the first AP device, wherein each of the third communication information comprises a third communication time period during which the corresponding STA device communicates with the first AP device.

7. The method according to claim 1, wherein the method further comprises:
determining a second message frame, wherein the second message frame comprises a first identification bit, and the first identification bit is used to indicate the first AP device to send the first message frame; and
sending the second message frame.

8. The method according to claim 7, wherein the first message frame is a beacon frame or a probe response frame.

9. A communication method, applied to a second AP device, the method comprising:
receiving a first message frame, wherein the first message frame comprises first communication information, the first communication information comprises a first communication time period during which a first AP device communicates with at least one first STA device in a target OBSS, a communication connection is established between the first AP device and each of the first STA device, the target OBSS is an OBSS formed in a sub-7 GHz frequency band by a plurality of AP devices comprising the first AP device, and the second AP device is any AP device corresponding to the target OBSS except the first AP device.

10. The method according to claim 9, wherein each of the first communication time period is used to indicate that each AP device corresponding to the target OBSS except the first AP device does not communicate with a second STA device with which a communication connection has been established in the target OBSS during a corresponding first communication time period, and each of the second STA device does not establish a communication connection with the first AP device.

11. The method according to claim 9, wherein each of the first communication time period is further used to indicate that each AP device corresponding to the target OBSS except the first AP device is allowed to communicate with a third STA device that has established a communication connection in a 45 GHz frequency band and/or a 60 GHz frequency band during a corresponding first communication time period.

12. The method according to claim 9, wherein the method further comprises:
receiving a time sync function (TSF) parameter, wherein the TSF parameter is used to perform time synchronization with the first AP device.

13. The method according to claim 9, wherein the method further comprises:
sending second communication information, wherein the second communication information comprises a second communication time period during which the second AP device communicates with a STA device with which a communication connection has been established.

14. The method according to claim 9, wherein the method further comprises:
receiving fourth communication information sent by each STA device that has established a communication connection with the second AP device, wherein each of the fourth communication information comprises a fourth communication time period during which the corresponding STA device communicates with the second AP device.

15. The method according to claim 9, wherein the method further comprises:
receiving a second message frame, wherein the second message frame comprises a first identification bit, and the first identification bit is used to indicate the first AP device to send the first message frame.

16. The method according to claim 15, wherein the first message frame is a beacon frame or a probe response frame.

17. A first access point (AP) device, comprising: a memory, a processor, and a computer program stored in the memory and executable on the processor, wherein when the processor executes the program, the processor is configured to:
determine a first message frame, wherein the first message frame comprises first communication information, the first communication information comprises a first communication time period during which the first AP device communicates with at least one first station (STA) device in a target overlapping basic service set (OBSS), a communication connection is established between the first AP device and each of the first STA device, and the target OBSS is an OBSS formed in a sub-7 GHz frequency band by a plurality of AP devices comprising the first AP device; and
send the first message frame.

18. (canceled)

19. A second access point (AP) device, wherein the AP device comprises a memory, a processor, and a computer program stored in the memory and executable on the processor, wherein when the processor executes the program, the method according to claim 9 is implemented.

20. A computer-readable storage medium, wherein a computer program is stored on the computer-readable storage medium, and when the computer program is executed by a processor, the method according to claim 1 is implemented.

21. A computer-readable storage medium, wherein a computer program is stored on the computer-readable storage medium, and when the computer program is executed by a processor, the method according to claim 9 is implemented.
